(19) United States
(12) Patent Application Publication
(10) Pub. No.: US 2014/0027429 A1
(43) Pub. Date: Jan. 30, 2014

(54) METHOD FOR DYNAMIC FEED PRESSURE ADJUSTMENT

(71) Applicant: Bruce John Chantry, Solon, OH (US)

(72) Inventor: Bruce John Chantry, Solon, OH (US)

(73) Assignee: LINCOLN GLOBAL, INC., City of Industry, CA (US)

(21) Appl. No.: 14/043,117

(22) Filed: Oct. 1, 2013

Related U.S. Application Data
(63) Continuation-in-part of application No. 11/755,821, filed on May 31, 2007.

(51) Int. Cl. B23K 9/12; B23K 9/095

(52) U.S. Cl. CPC B23K 9/124; B23K 9/0956
USPC 219/137.7

(57) ABSTRACT

The invention relates to devices, systems, and methods for automatic feed adjustment during welding operations using a pressure measuring device and a welding wire knowledge database to adjust tension between at least one pair of wire feed rolls, at least one of which is a drive roll.

### CROSS-REFERENCE TO RELATED APPLICATIONS

This application is a continuation-in-part application of pending U.S. patent application Ser. No. 11/755,821 filed 31 May 2007, and claims priority thereto and fully incorporates by reference the same.

### TECHNICAL FIELD

The invention described herein pertains generally to devices, systems, and methods for automatic feed adjustment during welding operations.

### BACKGROUND OF THE INVENTION

In the related art, there are various types of welding processes, including processes which utilize a continuous wire feed as a welding electrode.

A diagrammatical representation of such a related art continuous wire feed welding process is illustrated in FIG. 1, which illustrates a welding system 1 which includes control circuit 10, power source 20, motor 12, and spool 30. Spool 30 contains wire 35 spooled thereon. Motor 12 drives opposing rollers 14 to take up wire 35 from spool 30 and send it to gun 22. The operator utilizes gun 22 to form a weld on workpiece 40. As the weld is formed on workpiece 40, wire 35 is consumed at gun 22, and is replaced by feeding more wire 35 to gun 22 by action of motor 12 and rollers 14 at a constant rate.

Different types of wires 35 are available for different welding applications. The selection of a particular type of wire depends on several factors, including, e.g., the type of material being welded, the weld design, material surface conditions, quality concerns, and process variation concerns. Due to these considerations, the different types of wires have widely varying diameters and compositions.

As mentioned above, in the system illustrated in FIG. 1, wire 35 is fed to gun 22 at a constant rate during a welding operation. This rate is set by the operator via a variable knob on control circuit 10 before the welding operation begins. Different rates are appropriate for different welding applications. For example, a thicker material to be welded may require a faster feed, while a thinner material may require a slower speed to avoid burn-through.

In order to provide the desired feed rate, an amount of tension between rollers 14 is also adjustable by the operator, before the welding operation begins. The term tension is broadly utilized in this context to represent both a “tension” force acting on each roller 14 in a direction toward the other (e.g., as created by a spring member connecting the two rollers 14) and as a “pressure” forcing the rollers 14 toward each other (e.g., as created by spring members on opposite sides of the two rollers 14). This tension between rollers 14 acts to draw wire 35 off spool 30, and feed wire 35 toward gun 22. The adjustment is typically provided by a small thumb-wheel or other adjustment mechanism.

The tension between rollers 14 is set in view of the diameter and composition of the wire 35, and remains constant during the welding operation. Unfortunately, if the tension between rollers 14 is set too high, the rollers 14 will deform the wire 35 as it passes therethrough. Such a deformed wire 35 can jam gun 22. On the other hand, if the pressure between rollers 14 is set too low, wire 35 will be fed to gun 22 at an erratic rate, which results in an erratic welding arc and poor weld quality.

Further, even if the tension is set properly on a first section of wire 35, there is inherent variability in the diameter of wire 35 due to such factors as manufacturing process variation and/or damage during shipment or storage. In other words, wire 35 may not have a constant diameter along its length. Thus, as wire 35 is fed to gun 22 through rollers 14, the tension set before the welding operation (in view of a beginning diameter of wire 35) might become inappropriate, and wire 35 might begin to deform or be erratically fed, as described above. In addition, changes in the gun 22 position along with the condition of the liner in gun 22, among other causes, could cause the tension to be set correctly initially and not to be sufficient if there are loops in gun 22, for instance.

The above problems demand an improvement in the related art system.

### SUMMARY OF THE INVENTION

In accordance with the present invention, there is provided an automatic feed tension adjuster that overcomes the problems of the related art.

At least one aspect of the invention includes a process for controlling tension between wire feed rollers on a welding wire comprising the steps of: feeding a wire through at least one pair of rollers, at least one of said pair of rollers being a drive roller, said at least one pair of rollers having a tension therebetween; measuring an observed speed of the wire after it exits from between the pair of rollers; comparing a driven speed of the wire, said driven speed calculated based upon a motor speed and a roller diameter of at least one of the rollers, with the observed speed of the wire as measured by a wire speed sensor as the wire passes the wire speed sensor; and at least periodically measuring said tension between said at least one pair of rollers using a pressure measuring means (e.g., a pressure transducer or other suitable device); and communicating said driven speed, said observed speed and said tension to a knowledge database of specific wire parameters to determine whether a mismatch between said driven speed and said observed speed is attributable to tension between said at least one pair of rollers or to other factors; and automatically adjusting the tension between the pair of rollers if said step of communicating with said knowledge database determines that said tension needs to be increased or decreased.

The method above further includes calculating the driven speed of the wire by taking into account the rotational speed and the diameter of at least one of the pair of rollers and increasing the tension between the pair of rollers when the driven speed of the wire is greater than the fed speed of the wire and the tension between said at least one pair of rollers is less than the maximum tension allowable from the knowledge database.

In an aspect of the invention, the method further includes entering wire data via a user interface and communication of the same with the knowledge database, wherein the wire data comprises a wire diameter; and determining an initial tension between the at least one pair of rollers, and a maximum tension between the at least one pair of rollers, and a maximum tension between said at least one pair of rollers in view of the wire data.

In another aspect of the invention, an automatic wire feed adjuster is described which includes: a feeding mechanism comprising at least one pair of rollers that feeds a wire therebetween; a tension controller that adjusts a tension between the at least one pair of rollers; a pressure measuring means (e.g., pressure transducer) between the at least one pair of rollers; a knowledge database of welding wire parametric characteristics, including maximum and minimum parametric values for a defined set of characteristics; a control circuit that decides whether to instruct the tension controller to adjust the tension between the pair of rollers based upon a comparison of a first speed of the wire and a second speed of the wire and a tension value from said pressure transducer, the first speed being calculated based upon the motor speed and the roller diameter of at least one of the rollers, the second speed of the wire being directly measured by a wire speed sensor as the wire passes the wire speed sensor, said control circuit automatically communicating with said tension controller when said first and second speeds are not essentially equivalent, and said tension value for said specific welding wire has not been exceeded.

The automatic wire feed adjuster described above includes wherein the driven speed of the wire is calculated by taking into account the rotational speed and the diameter of at least one of the at least one pair of rollers and the control circuit increases the tension between the pair of rollers when the driven speed of the wire is greater than the fed speed of the wire.

The automatic wire feed adjuster described above further includes: a user interface for accepting wire data, wherein: the wire data comprises a wire diameter; and the control circuit determines an initial tension between the pair of rollers, and a maximum tension between the pair of rollers, in view of the wire data.

In an aspect of the invention, a process for controlling tension between wire feed rollers on a welding wire is described which includes the steps of: means for feeding a welding wire from a welding wire source to a welding gun, said means comprising at least one pair of rollers, at least one of said pair of rollers being a drive roller, said at least one pair of rollers having a tension therebetween; means for measuring an observed speed of the wire after it exits from between the pair of rollers; means for comparing a driven speed of the wire, said driven speed calculated based upon a motor speed and a roller diameter of at least one of the rollers, with the observed speed of the wire as measured by a wire speed sensor as the wire passes the wire speed sensor; and means for at least periodically measuring said tension between said at least one pair of rollers; communicating said driven speed, said observed speed and said tension to a knowledge database of specific wire parameters to determine whether a mismatch between said driven speed and said observed speed is attributable to tension between said at least one pair of rollers or to other factors; means for inputting specific welding wire information into a welding system comprising an input aspect and a knowledge database aspect; and automatically adjusting the tension between the pair of rollers if said step of communicating with said knowledge database determines that said tension needs to be increased or decreased.

The method above further includes calculating the driven speed of the wire by taking into account the rotational speed and the diameter of at least one of the pair of rollers and increasing the tension between the pair of rollers when the driven speed of the wire is greater than the fed speed of the wire and the tension between said at least one pair of rollers is less than the maximum tension allowable from the knowledge database.

The method described above further includes the step of entering wire data via a user interface and communication of the same with the knowledge database, wherein the wire data comprises a wire diameter; and determining an initial tension between the at least one pair of rollers, and a maximum tension between the at least one pair of rollers, and a maximum tension between said at least one pair of rollers in view of the wire data.

In as aspect of the invention, an automatic wire feed adjuster is described which includes: a feeding mechanism comprising at least one pair of rollers that feeds a wire therebetween; a tension controller that adjusts a tension between the at least one pair of rollers; a pressure detection means between the at least one pair of rollers; a knowledge database of welding wire parametric characteristics, including maximum and minimum parametric values for a defined set of characteristics; a means for entry of specific welding wire information by an operator for interfacing with said knowledge database; and a control circuit that decides whether to instruct the tension controller to adjust the tension between the pair of rollers based upon a comparison of a first speed of the wire and a second speed of the wire and a tension value from said pressure transducer, the first speed being calculated based upon the motor speed and the roller diameter of at least one of the rollers, the second speed of the wire being directly measured by a wire speed sensor as the wire passes the wire speed sensor, said control circuit automatically communicating with said tension controller when said first and second speeds are not essentially equivalent, and said tension value for said specific welding wire has not been exceeded.

The driven speed of the wire is calculated by taking into account the rotational speed and the diameter of at least one of the at least one pair of rollers and the control circuit increases the tension between the pair of rollers when the driven speed of the wire is greater than the fed speed of the wire.

The automatic wire feed adjuster further includes a user interface for accepting wire data, wherein: the wire data comprises a wire diameter; and the control circuit determines an initial tension between the pair of rollers, and a maximum tension between the pair of rollers, in view of the wire data.

The above stated aspects, as well as other aspects, features and advantages of the invention will become clear to those skilled in the art upon review when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawing which form a part hereof, and wherein:

FIG. 1 illustrates a diagrammatic representation of a welding system according to the related art; and

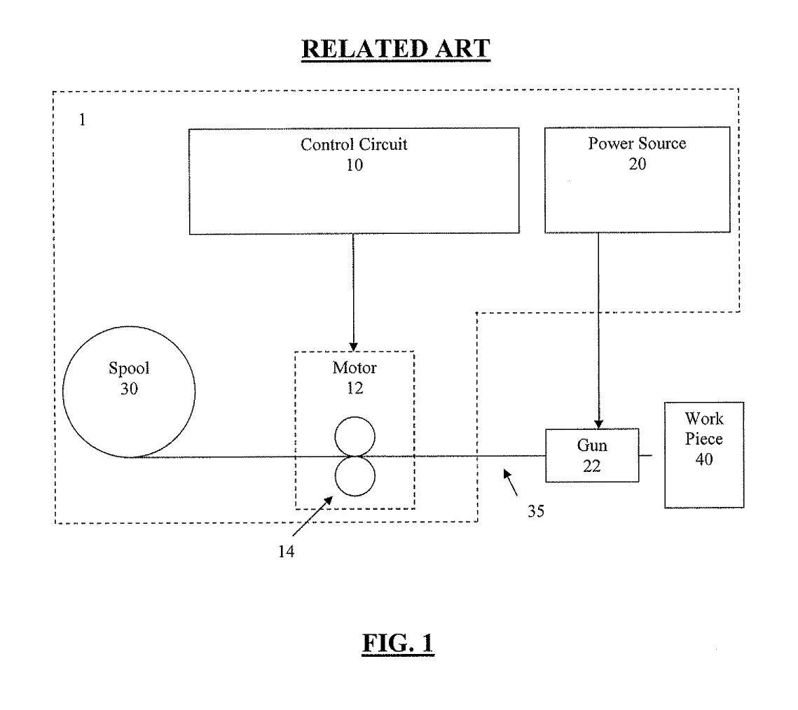

FIG. 2 illustrates a diagrammatic representation of a welding system according to an embodiment of the invention.

### DETAILED DESCRIPTION OF THE INVENTION

The best mode for carrying out the invention will now be described for the purposes of illustrating the best mode known to the applicant at the time of the filing of this patent application. The examples and figures are illustrative only and not meant to limit the invention, which is measured by the scope and spirit of the claims.

The invention relates to a an automatic feed adjuster is utilized to provide optimized wire feeding and welding.

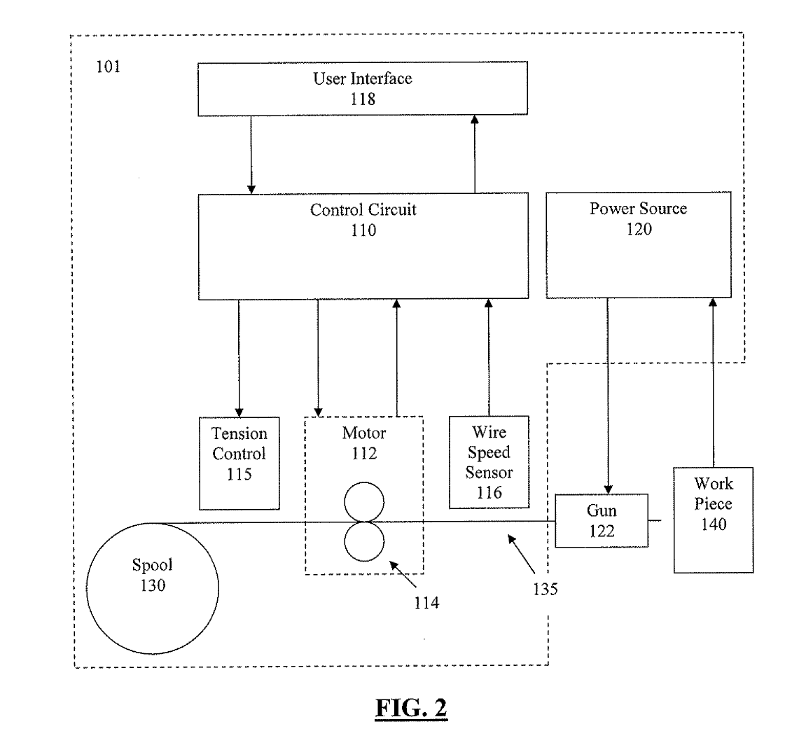

More specifically, as shown in FIG. 2, welding system 101 includes control circuit 110, power source 120, motor 112, tension control 115, wire speed sensor 116, user/data interface 118, and spool 130. Spool 130 contains wire 135 spooled thereon. Motor 112 drives opposing rollers 114 to take up wire 135 from spool 130 and send it to gun 122. The operator utilizes gun 122 to form a weld on workpiece 140. As the weld is formed on workpiece 140, wire 135 is consumed, and is replaced by motor 112.

User/data interface 118 provides an input for data regarding wire 135 to be entered into welding system 101. This wire data may include any particular information regarding wire 135, such as its diameter, length, configuration, manufacturer part number, internal part number, or any other physical, chemical or performance properties that may be useful.

The user/data interface 118 may include, without limitation, any digital, analog, or manual device whereby an operator can enter wire data (e.g., a Graphical User Interface, a text based input system, adjustment knobs, sliders, etc.) or any device that reads wire data from wire 135 or its packaging (e.g., a RFID) reader, magnetic or optical drive, bar code reader, etc.). Further, data regarding wire 135 is stored within welding system 101 for later use (or pre-stored before use), and simply be accessed by the operator through user/data interface 118. Data within welding system 101 regarding welding wire 135 will include at least maximum and minimum tension values for the drive/idler rolls for the wire feeder specific to a master database of welding wires, compositional characteristics which impact recommended tension values, wire diameters, length, configuration, manufacturer part number, internal part number, or any other physical, chemical or performance properties that may be useful, etc., i.e., the “knowledge database”.

Welding system 101 then utilizes wire data for wire 135 to initially adjust, and continuously control, the tension between rollers 114 (via tension control 115, e.g., a pressure transducer). More specifically, tension control 115 first adjusts the tension between rollers 114 to a setting equal to an initial tension that is equal to a minimum amount of tension between rollers 114 necessary to feed wire 135 to gun 122 without slipping. This initial minimum tension is determined according to the wire data (e.g., a diameter) of wire 135. The wire data may be input to welding system 101 as discussed above. While a pressure transducer is usable in this invention, the technology is not limited to such, and pressure measuring means includes, but is not limited to: force summing devices; mechanical pressure gauges; electromechanical pressure sensors; strain gauge transducers; bonded and unbounded strain gauges; sputtered strain gauges; semiconductor strain gauges; bonded discrete silicon strain gauges; diffused diaphragm sensors; sculptured diaphragm sensors; variable capacitance transducers; and piezoelectric transducers, piezoresistive sensors, load cells, etc.

Next, during the welding operation, as wire 135 is fed continuously through rollers 114, the tension control (pressure transducer) operates to continuously adapt the tension between rollers 114 to maintain a minimum amount of tension between rollers 114 necessary to feed wire 135 to gun 122 without slipping with constant querying of the knowledge database to determine that any slippage is attributable to tension issues, and not for example, attributable to welding wire composition or welding wire diameter issues. This operating minimum tension is determined by feedback data delivered to control circuit 110 from motor 112 and wire speed sensor 116, as described below.

The use of these minimum tensions avoids any erratic feeding of the wire 135 due to a tension that is set too low, and any possible deformation of the wire 135 due to a tension that is set too high. Further, as tension adjustments are accomplished automatically by tension control 115, the possibility of operator error influencing the feeding of wire 135 is drastically reduced.

As mentioned above, the operating minimum tension is determined by feedback data contained within the knowledge database. More specifically, when the welding system 101 is feeding wire 135 via motor 112 and opposing rollers 114, the control circuit 110 obtains a first wire speed of the wire 135 by measuring the speed of the motor 112 and taking into account the diameters of rollers 114. Additionally, control circuit 110 obtains a second wire speed from wire speed sensor 116, which directly measures the speed of wire 135 as it passes thereby. Control circuit 110 then compares the first and second wire speeds. If the wire speeds are the same, no slipping of wire 135 on opposing rollers 114 is occurring, and no tension adjustment is necessary. Thus, the control circuit 110 does not instruct the tension control 115 to modify the tension of rollers 114.

However, if the first wire speed calculated from the motor speed is higher than the second wire speed read from the wire sensor 118, the wire 135 is slipping on opposing rollers 114. Thus, control circuit 110 will instruct the tension control 115 to increase the tension between opposing rollers 114 until the first and second wire speeds become equivalent (i.e., until the wire 135 stops slipping) based upon interrogation of a knowledge database of welding wires which is initiated at least upon the detection of a mismatch between a set wire feed rate and an observed wire feed rate noted above and at least one pressure transducer reading, the knowledge database including parametric maximums and minimums for a defined range of welding wire characteristics.

Control circuit 110 will continue to increase the tension between opposing rollers 114 until it reaches a maximum value. The maximum value may be set in view of many factors, including a point at which the wire 135 will begin to deform because of the tension. This maximum value is determined according to the wire data (e.g., a diameter, type, size, etc.) of wire 135 in the knowledge database.

As described in one aspect of the invention, increasing or decreasing tension (up to either a maximum and/or minimum value) between opposing rollers 114 is effected by a wire speed comparison calculation between the input wire feed speed and the observed wire feed speed. While this is appropriate to a first approximation, for some welding wires, particularly easily deformable welding wires, this may still result in increasing the tension between opposing rollers to a value which is too high to prevent wire deformation. Incorporation of a pressure transducer into the above dynamic system in combination with the wire speed comparison, represents an improvement over the base calculation comparison. When the calculated wire speed is faster than the measured wire speed, it is not possible to determine if slippage is attributable only due to tension which is too low. By combining pressure readings in combination with the wire speed comparison and in further combination with a knowledge database of welding wires present in welding system 101, the system is able to factor wire size and type, coupled with maximum and minimum pressure values to determine if increasing pressure will resolve the slippage issue or whether the slippage is attributable to other factors which are not related to roller tension as to provide this information to the operator through user/data interface 118 in the form of an informational message or other suitable mechanism, e.g., a warning alarm, to alert the operator that roller tension may not be the solution to the discrepancy between calculated wire speed and observed or measured wire speed.

In one implementation of the invention, idler roll pressure arm manual control is eliminated and tension control 115 is effected by a combination of a servo motor and pressure transducer combination driven by control circuit 110 based upon information previously provided by the operator through user interface 118. When using the system in this mode, the idler arm is a motor-driven pressure arm tied into the control circuit which can rapidly increase or decrease idler arm pressure. The operator has limited ability to exceed recommended maximum and/or minimum tensions in that the knowledge database within welding system 101 controls these values. In another implementation of the invention, the idler roll pressure arm still has manual control, but ultimate control of tension is effected by the comparison of the pressure transducer roller tension values in combination with the knowledge database maximum or minimum tension values specific to a welding wire within welding control circuit 110, regardless of any manually set value, thereby preventing an operator from the thought process of many operators, which is that if a little tension is good, then a lot is better, which often exacerbates the problem, particularly with aluminum and cored wires, which have much different compression characteristics than more traditional solid wires.

The sampling rate for determining the first and second wire speed is not limited, but should be set to optimize the welding operation.

The wire speed sensor can be any sensor that is capable of providing the required wire speed data, including, without limitation, electronic or mechanical sensors that contact or do not contact the wire 135. While the wire speed sensor in FIG. 2 is positioned after rollers 114, since the wire is continuous, the speed sensor can be placed at any point along the length of wire 135.

Opposing rollers 114 are illustrated in this exemplary embodiment. However, opposing rollers are not required, and the invention is not limited thereto. For example, the invention is equally applicable to system having more or less than two rollers, or to systems that use other driving concepts for wire 135 that create some kind of pressure on the wire. This pressure can be adjusted similarly to the tension described in the exemplary embodiment.

Further, there is no limitation to the amount of rollers 114 that are powered by motor 112. For example, one roller of the rollers 114 may be powered, and one roller may be an unpowered following roller.

The term tension is broadly used in the context of this invention. It means either a “tension” force acting on each roller in a direction toward the other and as a “pressure” forcing the rollers toward each other. This tension can be created by spring members, elastic members, levers, electric motors, or any other such device. The amount of tension is adjustable by adjusting the pressure or tension exerted by these devices, which in turn adjusts the tension between the opposing rollers. The amount of pressure or tension exerted by the devices can be controlled by the tension control 115, or other such component, via electrical or mechanical means.

As mentioned above, the exemplary embodiment utilizes wire data to set an initial tension equal to a minimum amount of tension between rollers 114. However, the invention is not limited thereto, and the initial tension may be set at a point between the minimum and maximum tension. Thereafter, the tension control may operate to reduce the tension until the feedback data indicates that there is slipping of the wire, at which point tension may again be increased according to the process described above.

Although FIG. 2 illustrates a single welding system 101 including spool 130, motor 112, opposing rollers 114, tension controller 116 and wire speed sensor 118, each of these elements may be independently provided, or grouped together in any desirable combination. For example, roller 114 may be removably attached to a welding machine, located close to the machine, or built into the machine, depending on a particular manufacturer's style and type of machine. Further, the invention may be retrofitted to existing welding systems by adding the necessary components.

The welding system described herein is applicable to any welding system that utilizes a wire feed.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process for controlling tension between wire feed rollers on a welding wire comprising the steps of:
feeding a wire through at least one pair of rollers, at least one of said pair of rollers being a drive roller, said at least one pair of rollers having a tension therebetween;
measuring an observed speed of the wire after it exits from between the pair of rollers;
comparing a driven speed of the wire, said driven speed calculated based upon a motor speed and a roller diameter of at least one of the rollers, with the observed speed of the wire as measured by a wire speed sensor as the wire passes the wire speed sensor; and
at least periodically measuring said tension between said at least one pair of rollers using a pressure measuring means;
communicating said driven speed, said observed speed and said tension to a knowledge database of specific wire parameters to determine whether a mismatch between said driven speed and said observed speed is attributable to tension between said at least one pair of rollers or to other factors; and
automatically adjusting the tension between the pair of rollers if said step of communicating with said knowledge database determines that said tension needs to be increased or decreased.

2. The method of claim 1 wherein
said pressure measuring means is selected from the group consisting of force summing devices, mechanical pressure gauges, electromechanical pressure sensors, strain gauge transducers, bonded and unbounded strain gauges, sputtered strain gauges, semiconductor strain gauges, bonded discrete silicon strain gauges, diffused diaphragm sensors, sculptured diaphragm sensors, variable capacitance transducers, piezoelectric transducers, piezoresistive sensors, load cells and pressure transducers.

3. The method of claim 1 further comprising:
calculating the driven speed of the wire by taking into account the rotational speed and the diameter of at least one of the pair of rollers.

4. The method of claim 1, further comprising:
increasing the tension between the pair of rollers when the driven speed of the wire is greater than the fed speed of the wire and the tension between said at least one pair of rollers is less than the maximum tension allowable from the knowledge database.

5. The method of claim 1, further comprising:
entering wire data via a user interface and communication of the same with the knowledge database, wherein the wire data comprises a wire diameter; and
determining an initial tension between the at least one pair of rollers, and a maximum tension between the at least one pair of rollers, and a maximum tension between said at least one pair of rollers in view of the wire data.

6. An automatic wire feed adjuster, comprising:
a feeding mechanism comprising at least one pair of rollers that feeds a wire therebetween;
a tension controller that adjusts a tension between the at least one pair of rollers;
a pressure measuring means between the at least one pair of rollers;
a knowledge database of welding wire parametric characteristics, including maximum and minimum parametric values for a defined set of characteristics;
a control circuit that decides whether to instruct the tension controller to adjust the tension between the pair of rollers based upon a comparison of a first speed of the wire and a second speed of the wire and a tension value from said pressure measuring means, the first speed being calculated based upon the motor speed and the roller diameter of at least one of the rollers, the second speed of the wire being directly measured by a wire speed sensor as the wire passes the wire speed sensor, said control circuit automatically communicating with said tension controller when said first and second speeds are not essentially equivalent, and said tension value for said specific welding wire has not been exceeded.

7. The automatic wire feed adjuster wherein
said pressure measuring means is selected from the group consisting of force summing devices, mechanical pressure gauges, electromechanical pressure sensors, strain gauge transducers, bonded and unbounded strain gauges, sputtered strain gauges, semiconductor strain gauges, bonded discrete silicon strain gauges, diffused diaphragm sensors, sculptured diaphragm sensors, variable capacitance transducers, piezoelectric transducers, piezoresistive sensors, load cells and pressure transducers.

8. The automatic wire feed adjuster recited in claim 7, wherein
the driven speed of the wire is calculated by taking into account the rotational speed and the diameter of at least one of the at least one pair of rollers.

9. The automatic wire feed adjuster recited in claim 8, wherein
the control circuit increases the tension between the pair of rollers when the driven speed of the wire is greater than the fed speed of the wire.

10. The automatic wire feed adjuster recited in claim 6, further comprising
a user interface for accepting wire data, wherein:
the wire data comprises a wire diameter; and
the control circuit determines an initial tension between the pair of rollers, and a maximum tension between the pair of rollers, in view of the wire data.

11. A process for controlling tension between wire feed rollers on a welding wire comprising the steps of:
means for feeding a welding wire from a welding wire source to a welding gun, said means comprising at least one pair of rollers, at least one of said pair of rollers being a drive roller, said at least one pair of rollers having a tension therebetween;
means for measuring an observed speed of the wire after it exits from between the pair of rollers;
means for comparing a driven speed of the wire, said driven speed calculated based upon a motor speed and a roller diameter of at least one of the rollers, with the observed speed of the wire as measured by a wire speed sensor as the wire passes the wire speed sensor; and
means for at least periodically measuring said tension between said at least one pair of rollers;
communicating said driven speed, said observed speed and said tension to a knowledge database of specific wire parameters to determine whether a mismatch between said driven speed and said observed speed is attributable to tension between said at least one pair of rollers or to other factors;
means for inputting specific welding wire information into a welding system comprising an input aspect and a knowledge database aspect; and
automatically adjusting the tension between the pair of rollers if said step of communicating with said knowledge database determines that said tension needs to be increased or decreased.

12. The method of claim 11 wherein
said means for at least periodically measuring said tension is selected from the group consisting of force summing devices, mechanical pressure gauges, electromechanical pressure sensors, strain gauge transducers, bonded and unbounded strain gauges, sputtered strain gauges, semiconductor strain gauges, bonded discrete silicon strain gauges, diffused diaphragm sensors, sculptured diaphragm sensors, variable capacitance transducers, piezoelectric transducers, piezoresistive sensors, load cells and pressure transducers.

13. The method of claim 12 further comprising:
calculating the driven speed of the wire by taking into account the rotational speed and the diameter of at least one of the pair of rollers.

14. The method of claim 11, further comprising:
increasing the tension between the pair of rollers when the driven speed of the wire is greater than the fed speed of the wire and the tension between said at least one pair of rollers is less than the maximum tension allowable from the knowledge database.

15. The method of claim 11, further comprising:
entering wire data via a user interface and communication of the same with the knowledge database, wherein the wire data comprises a wire diameter; and
determining an initial tension between the at least one pair of rollers, and a maximum tension between the at least one pair of rollers, and a maximum tension between said at least one pair of rollers in view of the wire data.

16. An automatic wire feed adjuster, comprising:
a feeding mechanism comprising at least one pair of rollers that feeds a wire therebetween;
a tension controller that adjusts a tension between the at least one pair of rollers;
a pressure detection means between the at least one pair of rollers;
a knowledge database of welding wire parametric characteristics, including maximum and minimum parametric values for a defined set of characteristics;
a means for entry of specific welding wire information by an operator for interfacing with said knowledge database; and
a control circuit that decides whether to instruct the tension controller to adjust the tension between the pair of rollers based upon a comparison of a first speed of the wire and a second speed of the wire and a tension value from said pressure detection means, the first speed being calculated based upon the motor speed and the roller diameter of at least one of the rollers, the second speed of the wire being directly measured by a wire speed sensor as the wire passes the wire speed sensor, said control circuit automatically communicating with said tension controller when said first and second speeds are not essentially equivalent, and said tension value for said specific welding wire has not been exceeded.

17. The automatic wire feed adjuster recited in claim 16, wherein
said pressure detection means is selected from the group consisting of force summing devices, mechanical pressure gauges, electromechanical pressure sensors, strain gauge transducers, bonded and unbounded strain gauges, sputtered strain gauges, semiconductor strain gauges, bonded discrete silicon strain gauges, diffused diaphragm sensors, sculptured diaphragm sensors, variable capacitance transducers, piezoelectric transducers, piezoresistive sensors, load cells and pressure transducers.

18. The automatic wire feed adjuster recited in claim 17, wherein
the driven speed of the wire is calculated by taking into account the rotational speed and the diameter of at least one of the at least one pair of rollers.

19. The automatic wire feed adjuster recited in claim 18, wherein
the control circuit increases the tension between the pair of rollers when the driven speed of the wire is greater than the fed speed of the wire.

20. The automatic wire feed adjuster recited in claim 16, further comprising
a user interface for accepting wire data, wherein:
the wire data comprises a wire diameter; and
the control circuit determines an initial tension between the pair of rollers, and a maximum tension between the pair of rollers, in view of the wire data.
